(19) United States
(12) Patent Application Publication
(10) Pub. No.: US 2012/0092184 A1
(43) Pub. Date: Apr. 19, 2012

(54) Method for Synchronizing Meter Clocks in a Network

(75) Inventors: Jim Carr, Monticello, IN (US); Joel Charland, Granby (CA); Michel Veillette, Waterloo (CA)

(73) Assignee: Trilliant Incorporated, Redwood CIty, CA (US)

(21) Appl. No.: 13/275,682

(22) Filed: Oct. 18, 2011

Related U.S. Application Data
(60) Provisional application No. 61/394,021, filed on Oct. 18, 2010.

(51) Int. Cl. G08C 15/08

(52) U.S. Cl. 340/870.14

(57) ABSTRACT

Methods and systems are provided for synchronizing meter clocks in both basic residential meters and in advanced and C&I meters with advanced communication modules. The synchronization methods and systems provide easy-to-manage solutions from the head end, without impacting billing data.

### CROSS-REFERENCE TO RELATED APPLICATIONS

The present application claims benefit of similarly titled U.S. provisional patent application Ser. No. 61/394,021 filed Oct. 18, 2010, which is incorporated herein by reference in its entirety.

### FIELD OF THE INVENTION

The present invention relates generally to time synchronization of electric meters in a wireless mesh Neighborhood Area Network.

### BACKGROUND OF THE INVENTION

A mesh network is a wireless network configured to route data between nodes within a network. It allows for continuous connections and reconfigurations around broken or blocked paths by retransmitting messages from node to node until a destination is reached. Mesh networks differ from other networks in that the component parts can all connect to each other via multiple hops. Thus, mesh networks are self-healing—the network remains operational when a node or a connection fails.

Advanced Metering Infrastructure (AMI) or Advanced Metering Management (AMM) are systems that measure, collect and analyze utility usage, from advanced devices such as electricity meters, gas meters, and water meters, through a network on request or a pre-defined schedule. This infrastructure includes hardware, software, communications, customer associated systems and meter data management software. The infrastructure collects and distributes information to customers, suppliers, utility companies and service providers. This enables these businesses to either participate in, or provide, demand response solutions, products and services. Customers may alter energy usage patterns from normal consumption patterns in response to demand pricing. This improves system load and reliability.

In many wireless mesh Neighborhood Area Network (NAN), the network access point provides an accurate time base reference for all devices that are associated with it. It is important that each of the devices maintain an accurate time base such that meter readings may be compiled over programmable intervals (e.g., for time-of-use billing and load profiling). Accordingly, the access point should keep a reliable real-time clock that is accurate to the nearest minute or better. In addition, any corrections to that clock must be done so that billing data is not distorted or corrupted.

Unfortunately, conventional access points are configured to synchronize every 6 hours, and any time adjustments that may be required are hard time set adjustments (i.e., the adjustment to the correct time is made directly without any incremental adjustments). This may allow for inaccurate data to be collected when, for example, the access point clock is inaccurate or a device associated with the access point loses power.

Accordingly, there is a need in the art for synchronization methods, which minimize any impact to meter billing data while at the same time providing an easy-to-manage solution from the head end.

### SUMMARY OF THE INVENTION

The exemplary embodiments herein describe methods and systems for synchronizing meter clocks in both basic residential meters and in advanced and C&I meters with advanced communication modules. The synchronization methods and systems provide easy-to-manage solutions from the head end, without impacting billing data.

In one aspect of the invention, a method of synchronizing a network device connected to a standard communication module is provided. The clock of the standard communication module is synchronized with the clock of an access point in the mesh network. The method includes receiving, by the network device, a correct time from the access point, where the access point is connected to a server. The method also includes determining an offset of about 1 second or greater between the correct time and a clock time of the standard communication module. Next, the clock is incrementally adjusted to the correct time without any notification to the server if the offset is less than 5 minutes. The clock is incrementally adjusted to the correct time, an error flag is set, and, optionally, an error message is sent to the server if the offset is from 5 minutes to less than 15 minutes. Otherwise, an error flag is set, an error message is sent to the server, and the clock is directly set to the correct time upon receiving a command from the server, if the offset is 15 minutes or greater.

In another aspect of the invention, a mesh network system is provided. The mesh network system includes a server; an access point in communication with the server, the access point comprising an access point clock set to a correct time; and at least one mesh device in communication with the access point, the mesh device including a communication module having a device clock set to a clock time. The communication module may determine an offset of about 1 second or greater between the correct time and a clock time. Accordingly, the communication module incrementally adjusts the device clock to the correct time without any notification to the server if the offset is less than 5 minutes; incrementally adjusts the clock to the correct time, sets an error flag, and, optionally, sends an error message to the server if the offset is from 5 minutes to less than 15 minutes; and/or sets an error flag, sends an error message to the server, and directly sets the device clock to the correct time upon receiving a command from the server, if the offset is 15 minutes or greater.

In yet another aspect of the invention, a method of synchronizing a smart mesh network device including an advanced communication module and a device clock with an access point is provided. The method includes receiving, by the advanced communication module, a correct time from the access point; determining an offset between the correct time and a module clock time from a module clock of the advanced communication module; determining that the offset is greater than a minimum offset; and adjusting the module clock to the correct time and, optionally, sending an error message to a server.

In certain embodiments, the method also includes receiving, by the advanced communication module, a device clock time from a device clock of the smart mesh network device; determining, by the advanced communication module, an offset between the correct time and the device clock time; determining, by the advanced communication module, that the offset is greater than a minimum drift parameter and directly adjusting the device clock to the correct time; and setting an error flag, and, optionally, sending an error message to a server when the offset is determined by the advanced communication module to be greater than a maximum drift parameter.

In another aspect of the invention, a mesh network system is provided. The system includes a server; an access point in communication with the server, the access point including an access point clock set to a correct time; at least one smart mesh device in communication with the access point, the smart mesh device having a device clock set to a device clock time and an advanced communication module having a module clock set to a module clock time. Generally, the advanced communication module determines an offset between the correct time and the module clock time; determines that the offset is greater than a minimum offset; and adjusts the module clock to the correct time.

In certain embodiments, the advanced communication module receives a device clock time from the device clock; determines an offset between the correct time and the device clock time; determines that the offset is greater than a minimum drift parameter; adjusts the device clock to the correct time; and sets an error flag, and, optionally, sends an error message to the server when the offset is greater than a maximum drift parameter.

These and other aspects of the invention will be better understood by reading the following detailed description and appended claims.

### BRIEF DESCRIPTION OF THE FIGURES

FIG. 1 illustrates an exemplary system for providing AMI communications over a mesh network.

### DETAILED DESCRIPTION

All terms used herein are intended to have their ordinary meaning in the art unless otherwise provided.

The methods described herein are applicable to both standard communication modules in basic residential meters and advanced communication modules in advanced and commercial and industrial (C&I) meters.

### AMI Mesh Networks

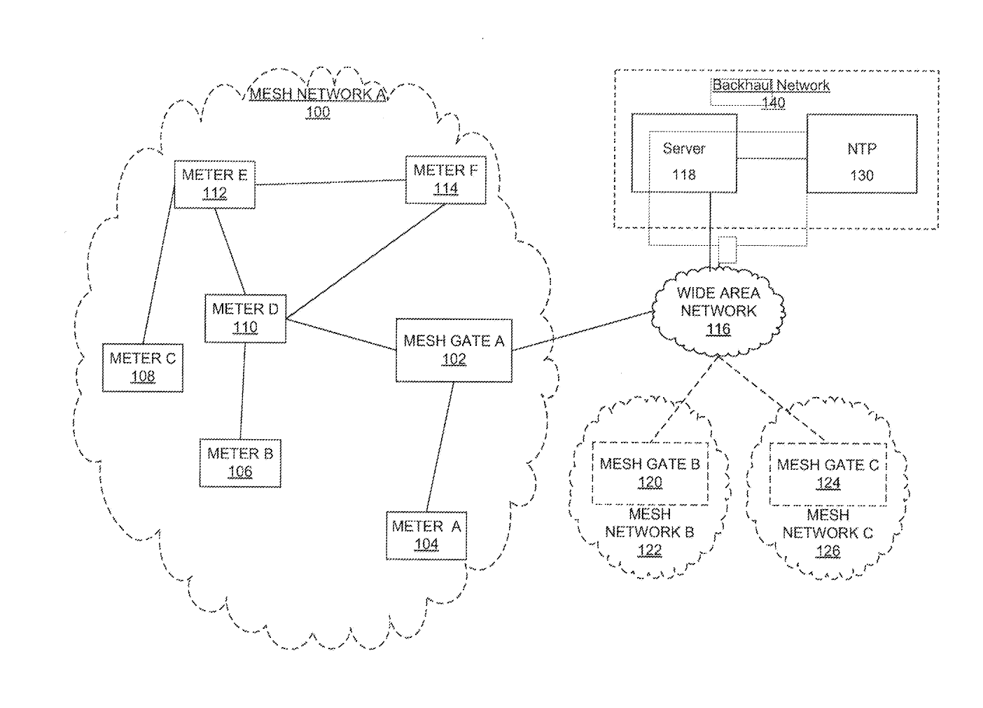

Refuting to FIG. 1, an exemplary system for providing AMI communications over a mesh network is illustrated. A mesh network A 100 may include a mesh gate A 102 and a plurality of meters: meters A 104, B 106, C 108, D 110, E 112, and F 114. A mesh gate may also be referred to as a NAN-WAN gate, a collector, a concentrator, or an access point. The mesh gate A 102 may communicate with a server 118 over a wide area network 116. Optionally, a mesh gate B 120 and a mesh network B 122 may also communicate with the server 118 over the wide area network (WAN) 116.

The mesh network A 100 may include a plurality of mesh gates and meters which cover a geographical area. The meters may include utility sensors and be part of an AMI system and communicate with the mesh gates over the mesh network. For example, the AMI system may monitor utilities usage, such as gas, water, or electricity usage and usage patterns. Alternative mesh devices include thermostats, user displays, and other components for monitoring utilities.

The mesh gate A 102 may provide a gateway between the mesh network A 100 and a server or “head end” 118, discussed below. The mesh gate A 102 may include a mesh radio to communicate with the mesh network A 100 and a WAN communication interface to communicate with a WAN.

The mesh gate A 102 may aggregate information from meters within the mesh network A 100 and transmit the information to the server 118. It will be appreciated that while only one mesh gate is depicted in the mesh network A 100, any number of mesh gates may be deployed within a mesh network, for example, to improve transmission bandwidth to the server and provide redundancy in the mesh network.

The meters A 104, B 106, C 108, D 110, E 112, and F 114 may each be a mesh device. The meters may be associated with the mesh network A 100 through direct or indirect communications with the mesh gate A 102. Each meter may forward transmissions from other meters within the mesh network A 100 towards the mesh gate A. It will be appreciated that while only six meters are depicted in the mesh network A 100, any number of meters may be deployed to cover any number of utility lines or locations.

As depicted, only meters A 104 and D 110 are in direct communications with mesh gate A 102. However, meters B 106, E 112 and F 114 can all reach mesh gate A 102 through meter D 110. Similarly, meter C 108 can reach mesh gate A 102 through meter E 112 and meter D 110.

The WAN 116 may be a communication medium capable of transmitting digital information. For example, the WAN 116 may be the Internet, a cellular network, a private network, a phone line configured to carry a dial-up connection, or any other network.

The head end server 118 may be a computing device configured to receive information, such as meter readings, from a plurality of mesh networks and meters. The server 118 may also be configured to transmit instructions to the mesh networks, mesh gates, and meters. The server 118 is a central processing system including one or more computing systems (i.e., one or more server computers). Where the head end includes more than one computing system, the computing systems can be connected by one or more networks and the system may be referred to as a “backhaul network” 140. Typically the head end server 118 is connected by a wired, wireless or combination of wired and wireless networks to a plurality of devices on a NAN.

The optional mesh gates B 120 and C 124 may be similar to mesh gate A 102, discussed above. Each mesh gate may be associated with a mesh network. For example, mesh gate B 120 may be associated with mesh network B 122 and mesh gate C 124 may be associated with mesh network C 126.

Each mesh network may include meters covering a geographical area, such as a premise, a house, a residential building, an apartment building, or a residential block. Alternatively, the mesh network may include a utilities network and be configured to measure utilities flow at each sensor. Each mesh gate communicates with the server over the WAN, and thus the server may receive information from and control a large number of meters or mesh devices. Mesh devices may be located wherever they are needed, without the necessity of providing wired communications with the server.

Descriptions of exemplary mesh networks, including electric meters, can be found in commonly owned U.S. patent application Ser. No. 12/275,252 entitled Method and System for Creating and Managing Association and Balancing of a Mesh Device in a Mesh Network” filed Nov. 21, 2008 which is incorporated herein by reference in its entirety.

### NAN Access Point Time Synchronization and Propagation

As shown in FIG. 1, each NAN access point 102, 120, 124 is typically configured to use its backhaul network 140 to automatically obtain a time reference from a Network Time Protocol (NTP) server 130 such as those hosted by the National Institute of Standards and Technology in the United States or the National Research Council in Canada. These NTP servers 130 provide Coordinated Universal Time (UTC) to within 10 milliseconds over the public Internet, with no information about time zones or daylight saving time. In a conventional mesh network, a NAN access point 102, 120, 124 is configured to synchronize every 6 hours, and any time adjustments that may be required to a NAN access point are hard time set adjustments (i.e., the adjustment to the correct time is made directly without any incremental adjustments).

Each NAN access point must also be properly configured with the correct time zone offset and daylight saving time parameters. The time zone offset specifies the number of minutes between local standard time and UTC, while the Daylight Saving Time parameters specify its start and stop date and corresponding offset in minutes from standard time.

Once a NAN access point (e.g., 102) is referenced to a time base, network synchronization is propagated to all devices (e.g., 104, 106, 108, etc.) through the mesh network, with each NAN device adjusting its clock to its associated NAN access point. Within the NAN subnetwork defined by the NAN access point and the NAN devices associated with it (e.g., 100), keep-alive messages are exchanged between each device and the NAN access point every hour to trace the latest tree route, send network management information such as network statistics and mesh neighborhood information, and allow centralized configuration of mesh parameters by the NAN access point. In addition, the keep-alive messages provide the mechanism to update network time synchronization. Each device autonomously initiates the exchange of keep-alive messages with the NAN access point (although the NAN access point can also explicitly initiate the exchange). In this way, the NAN access point clock is propagated throughout the network to allow devices to maintain network synchronization. Accuracy to the NAN access point's clock is maintained to within 100 s of milliseconds.

The referenced message exchange is explained more fully in co-pending U.S. patent application Ser. No. 12/554,135 filed Sep. 4, 2009 entitled System and Method for Implementing Mesh Network Communications Using a Mesh Network Protocol which is incorporated herein by reference in its entirety.

The real-time clock used in an NAN communication modules is designed to provide accurate timekeeping. The clock may be supported by a crystal oscillator that keeps the real-time clock accurate to within ±2 seconds per day under normal conditions and ±6 seconds per day in the event of a power outage when operating on backup power supplied by the real-time clock's dedicated supercapacitor. The communication module's real-time clock is then checked and synchronized with network time as received from the NAN access point.

The accuracy of the real-time clock in the module results in relatively few clock resets. Drift in the module's real-time clock greater than 5 minutes is extremely rare and would generally indicate a problem with the device. Typical clock drift should not exceed ±2 seconds per day.

### Basic Residential Meters

Basic residential meters do not themselves include a real-time clock to serve as a time base. Instead, a basic residential meter uses the real-time clock in a standard communication module (either retro-fitted to existing meters or developed as part of the meter) to compile meter readings over programmable intervals and thus support time-of-use billing and load profiling. The standard communication module should maintain a reliable real-time clock that is accurate to the nearest minute or better. In addition, any corrections to that clock must be done so that billing data is not distorted or corrupted.

For basic residential meters, the standard communication module's real-time clock is set to the time supplied by the NAN access point upon the device's first keep-alive message sent to its associated NAN access point. This hard set typically occurs only upon the initial association to the NAN or upon any re-association required by an extended power outage. Setting the clock activates the load profiler on the standard communication module. Typically, the load profiler will remain inactive as long as the clock has not been properly set.

The real-time clock on the standard communication module is backed up with a supercapacitor in the event of an outage, providing backup for a maximum period of 7 days. Upon power restoration, the standard communication module sends a keep-alive message to its NAN access point (as described above with respect to the network time propagation process) in a randomized time window of one hour.

After the initial time set, mesh network devices must be periodically synchronized to the associated NAN access point. Described herein is a time synchronization method for basic residential meters that is intended to be consistent with Validation, Editing, and Estimation (VEE) guidelines as advanced by the North American Energy Standards Board (NAESB) and published by the Edison Electric Institute (EEL, “Uniform Business Practices for Unbundled Electricity Metering, Volume Two”, 5 Dec. 2000, www.naesb.org/pdf/ubp120500.pdf). Key aspects of these guidelines related to meter time synchronization include:

The real-time clocks of meter reading devices or data acquisition systems (handhelds, laptops, etc) must be synchronized to a reference that is traceable to NIST (or equivalent national time reference) with an accuracy of ±1 minute;

Real-time clocks must be synchronized at least daily;

Acceptable clock offset is 3 minutes; any greater offset is considered a failed reading;

Meter readings with a time offset of less than 3 minutes can be corrected (edited), but readings with any greater offset must be discarded and the data estimated;

Metering Data Management (MDM) systems rely on the meter (or the Advanced Metering Infrastructure (“AMI”) network) to flag any clock error;

To avoid compromising the integrity of the metering process, MDM systems expect that the meter (or AMI network) will not perform any proration or other changes to the meter readings—changes to meter readings may only be made within a sealed meter, a production-certified MDM/VEE system, or billing system

In MDM or billing systems, once a clock error (or any other error) is identified for that reading, the entire reading must be flagged to allow it to be discarded and the data to be estimated—no attempt should be made to correct the error, even if the rules technically allow it

Any and all readings taken by a non-synchronized clock will be flagged as failed and discarded by the MDM

The time synchronizing methods described below ensure compliance with these guidelines so that the real-time clock of each meter can be corrected without manipulating readings or load profile data as calculated by a standard communication module in basic residential meters. Any intervals recorded with a time offset greater than 5 minutes are flagged by the standard communication module.

The standard communication module in a basic residential meter synchronizes its clock to the NAN access point based on the network time propagation process described above, typically synchronizing every 30 minutes or every hour. In the methods described herein, an offset as small as one second will then initiate time-smoothing.

In a first scenario, if the offset between the standard communication module's time and the NAN access point's time is between about 1 second and 5 minutes, the standard communication module gradually adjusts its real-time clock to the correct value without any notification to the server. The adjustment period required to adjust the real time clock is controlled by the correction_{factor} selected by the utility (described below).

In a second scenario, if the offset is 5 minutes or greater, but less than 15 minutes, the standard communication module gradually adjusts its real-time clock to the correct value, a “clock error” flag is raised, and, if the device is configured to send error reports in the event of time management issues, then a “clock drifted, trying to re-synchronize” error is generated and will be reported to the server as configured. The utility also has the option to individually initiate a “set clock” command to the module in order to directly set the clock to its correct value without incrementally adjusting the clock gradually.

In a third scenario, if the offset is 15 minutes or greater, no clock adjustment is performed, the “clock error” flag is raised, and the standard communication module generates a “clock drifted out of tolerance” error to be reported to the server. In order to correct the clock, the server must initiate a “set clock” command to the standard communication module in order to directly set the clock to its correct value (i.e., the clock is not gradually adjusted).

Typically, the process of gradually adjusting the standard communication module's real-time clock is controlled by a command from the NAN access point. The configured adjustment rate determines the increment by which it will take to adjust the clock to its desired correct value according to the following formula:

$$\frac{1}{{correction}_{factor}} \%$$

The value of correction_{factor} can range from 1 to 255 (whole numbers only) and is set to each utility's specific requirements. As a result, an adjustment of 1 second can take as little as 100 seconds (for a value of 1 and an adjustment rate of 10,000 ppm) or as long as 25500 seconds (for a value of 255 and an adjustment rate of 39.2 ppm) to accomplish. By this mechanism, no discontinuities to the interval profile data are introduced, and any standard communication module clock drift that is faster than the adjustment process will ultimately cause an error to be reported to the head end.

Examples of how the correction_{factor} affects the adjustment rate of the standard communication module are shown in Table 1, below:

TABLE 1

| correction_{factor} | Clock | Calculated Adjustment | Time to Adjust |
|---|---|---|---|
| Setting | Drift (s) | Time (s) | Meter |
| 1 (max setting) | 1 | 100 | .03 hrs./1.7 mins. |
| | 60 | 6,000 | 1.67 hrs. |
| | 900 | 90,000 | 25 hrs. |
| 40 (default setting) | 1 | 3,960 | 1.1 hrs. |
| | 60 | 237,600 | 66 hrs. |
| | 900 | 3,564,000 | 990 hrs. |

Advanced and C&I Meters with Advanced Communication Modules

Because advanced meters and C&I meters (collectively, “smart meters”) have their own native real-time clock for time-stamping and processing data, smart meters may be synchronized differently than basic residential meters with standard communication modules. An advanced communication module for smart meters allows the module to extract data from the meter autonomously and report it to the server per a configurable schedule, allows native meter alarms to be delivered in real-time, and, with respect to time synchronization, allows the advanced communication module to adjust the native meter clock with some autonomy.

An advanced communication module for smart meters is generally capable of delivering a more robust time management process than the standard communication module discussed above. Smart meters typically have an option for a battery or supercapacitor to provide power backup to the native meter clock. The advanced communication module for advanced and C&I meters adds value by offering the option for utilities to avoid the additional cost of these batteries or supercapacitors. Batteries in particular have an initial high investment cost as well as maintenance costs associated with monitoring and replacing the batteries as needed. For high-profile C&I accounts where precise time keeping is essential, using a meter's battery backup may be preferred; however, for a utility considering deployment of very large numbers of advanced metering endpoints for residential accounts, the time management approach described here provides an alternative that may be acceptable to a utility.

Upon the advanced communication module's first Keep-Alive message exchange with its associated NAN access point, the advanced communication module's real-time clock will be hard set to the time supplied by the NAN access point. Unlike in the case of a standard communication module in a basic residential meter, the advanced communication module's real-time clock has no impact on the activation of the native load profiler in the meter. With an advanced communication module installed in an advanced or C&I meter, the native meter clock synchronization process will be initiated to validate the native meter clock to the network clock every 1, 2, 4, 8, 12, or 24 hours, depending on how the advanced communication module has been configured.

The advanced communication module's real-time clock is synchronized to the NAN according to the network time propagation process described above. Unlike basic residential meters, however, the advanced communication module real-time clock will be set if any offset between it and network time is present. If a real-time clock offset of X has occurred, where X is configurable by the user, the clock will be reset and an alarm sent to the head end notifying the utility that the clock was out of tolerance and has been reset.

In some cases, a utility may not want to have some or all of their meters automatically synchronized to the NAN access point. In such cases, automatic meter clock and date setting can be disabled over the air (without requiring a site visit) for either an individual meter or a targeted group of meters. Whether or not automated clock synchronization is being utilized, the utility will always have the ability to manually set the meter clock from the head end. Any meter clock reset will result in an event being reported to the head end notifying the utility of the action. In addition, any meter clock reset will invoke the meter's own handling of a clock reset. For example, the meter may terminate the current interval and start a new one. Such meter behavior is meter-specific, depending on the particular meter Manufacturer and model.

If automated clock synchronization is employed, the advanced communication module may routinely compare the native meter clock to the module's real-time clock based on a utility-configurable parameter of every 1, 2, 4, 8, 12, or 24 hours. In addition, the utility can configure custom time error thresholds, such as but not limited to:
A minimum drift parameter (X) is configurable to ignore clock offsets equal to or less than a programmed value of X (in seconds); and/or
A maximum drift parameter (Y) is configurable to allow an automatic meter clock reset if the observed offset is equal to or less than the maximum drift parameter's programmed value (in seconds) and greater than the minimum drift parameter, X. Synchronization offsets exceeding the maximum drift parameter Y are reported to the head end to indicate that a manual clock reset procedure is required.

The following behavior can be observed against the meter clock during the network time synchronization process:
If the offset is less than X seconds, the meter clock is left as is;
If the offset is greater than X seconds but less than Y seconds, the advanced communication module directly sets the meter clock to the advanced communication module's real-time clock value;
If the offset is greater than Y seconds, the observed clock offset between the meter and advanced communication module clocks generates a “clock error” message that is reported to the head end for review. In one embodiment, a remote manual clock reset procedure may be initiated at the head end.

When the advanced communication module sets the meter clock, the process invokes the meter's handling of a clock reset. As a result, the current interval may be terminated and a new one started. Meter behavior will depend on the particular meter model; for example a “clock reset notification” generated by the meter may be sent to head end and/or status flags like “clock reset forward during interval” and “clock reset backwards during interval” may be generated by the meter and sent to the head end.

As with standard communication modules, the real-time clock on the advanced communication module is backed up with a supercapacitor in the event of a power outage, providing backup for a maximum period of 7 days. Upon power restoration, the advanced communication module sends a keep-alive message to its NAN access point in a randomized time window of one hour (as described in Section 3).

In order to reset the native meter clock as soon as possible after power restoration, especially when a battery or supercapacitor is not used to provide backup power to the native meter clock, the advanced communication module is able to determine whether its own real-time clock has lost backup power during the outage. If the advanced communication module's real-time clock has been fully powered during the outage, then the advanced communication module will immediately set the meter clock to its current time (if there is an offset between the clocks). However, if the advanced communication module's—real-time clock has lost power during the outage, then the advanced communication module will first attempt to synchronize to its associated NAN access point in order to reset the advanced communication module clock. In the worst case, resynchronization with the network will take up to 60 minutes—the Keep-Alive exchange process may be randomized to prevent traffic congestion on the NAN in the event of a widespread power outage and restoration. Once the advanced communication module's clock is set, the module will immediately validate and hard set the meter clock (if there is an offset between the clocks). Thereafter, the native meter clock synchronization process will then synchronize the meter clock to the advanced communication module clock every 1, 2, 4, 8, 12, or 24 hours.

If no backup battery or supercapacitor is present in the meter, then, in general, the worst-case scenario for a meter to operate without the correct synchronized time is ˜1 hour. Of course, other conditions may be present that could significantly influence the affected time (such as the network itself being unavailable). In these cases, if the meter clock is lost, meter data will be recorded in a default demand mode and load profiling will be disabled until the meter clock can be reset.

Unless specifically stated otherwise as apparent from the foregoing discussion, it is appreciated that throughout the description, discussions utilizing terms such as “processing” or “computing” or “calculating” or “determining” or “displaying” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The exemplary embodiments can relate to an apparatus for performing one or more of the functions described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a bus.

Some exemplary embodiments described herein are described as software executed on at least one processor, though it is understood that embodiments can be configured in other ways and retain functionality. The embodiments can be implemented on known devices such as a server, a personal computer, a special purpose computer, a programmed microprocessor or microcontroller and peripheral integrated circuit element(s), and ASIC or other integrated circuit, a digital signal processor, a hard-wired electronic or logic circuit such as a discrete element circuit, or the like. In general, any device capable of implementing the processes described herein can be used to implement the systems and techniques according to this invention.

It is to be appreciated that the various components of the technology can be located at distant portions of a distributed network and/or the internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The terms determine, calculate and compute, and variations thereof, as used herein are used interchangeably and include any type of methodology, process, mathematical operation or technique.

The invention described and claimed herein is not to be limited in scope by the specific embodiments herein disclosed since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims. All publications cited herein are incorporated by reference in their entirety.

1. A method of synchronizing a network device comprising a standard communication module having a clock with an access point in a mesh network, the method comprising:
receiving, by the network device, a correct time from the access point, the access point in communication with a server;
determining an offset of about 1 second or greater between the correct time and a clock time of the standard communication module;
incrementally adjusting the clock to the correct time without any notification to the server if the offset is less than 5 minutes;
incrementally adjusting the clock to the correct time, setting an error flag, and, optionally, sending an error message to the server if the offset is from 5 minutes to less than 15 minutes; and
setting an error flag, sending a error message to the server, and directly setting the clock to the correct time upon receiving a command from the server, if the offset is 15 minutes or greater.

2. A method according to claim 1, wherein the access point receives the correct time from the server.

3. A method according to claim 1, wherein said incrementally adjusting the real-time clock is controlled by a command from the access point.

4. A method according to claim 1, further comprising selecting an adjustment rate, adjustment period, and/or a correction_{factor}.

5. A mesh network system comprising:
a server;
an access point in communication with the server, the access point comprising an access point clock set to a correct time;
at least one mesh device in communication with the access point, the mesh device comprising a communication module having a device clock set to a clock time;
wherein the communication module determines an offset of about 1 second or greater between the correct time and a clock time; and
wherein the communication module:
incrementally adjusts the device clock to the correct time without any notification to the server if the offset is less than 5 minutes;
incrementally adjusts the clock to the correct time, sets an error flag, and, optionally, sends an error message to the server if the offset is from 5 minutes to less than 15 minutes; and
sets an error flag, sends an error message to the server, and directly sets the device clock to the correct time upon receiving a command from the server, if the offset is 15 minutes or greater.

6. A system according to claim 5, wherein the server is in communication with a Network Time Protocol server.

7. A system according to claim 6, wherein the server receives the correct time from the Network Time Protocol Server.

8. A system according to claim 5, wherein the access point receives the correct time from the server.

9. A system according to claim 5, wherein the access point clock is configured with the correct time zone offset and daylight saving time parameters.

10. A system according to claim 5, wherein said incrementally adjusting the device clock is controlled by a command from the access point.

11. A system according to claim 5, further comprising selecting an adjustment rate, adjustment period, and/or a correction_{factor}.

12. A system according to claim 5, wherein the access point clock comprises a crystal oscillator.

13. A method of synchronizing a smart mesh network device comprising an advanced communication module and a device clock with an access point, the method comprising:
receiving, by the advanced communication module, a correct time from the access point;
determining an offset between the correct time and a module clock time from a module clock of the advanced communication module;
determining that the offset is greater than a minimum offset; and
adjusting the module clock to the correct time and, optionally, sending an error message to a server.

14. The method of claim 13, wherein the minimum offset is configurable by a user.

15. A method according to claim 13 further comprising:
receiving, by the advanced communication module, a device clock time from a device clock of the smart mesh network device;
determining, by the advanced communication module, an offset between the correct time and the device clock time;
determining, by the advanced communication module, that the offset is greater than a minimum drift parameter and directly adjusting the device clock to the correct time; and
setting an error flag, and, optionally, sending an error message to a server when the offset is determined by the advanced communication module to be greater than a maximum drift parameter.

16. A method according to claim 15, wherein the minimum and/or maximum drift parameters are configurable by a user.

17. A mesh network system comprising:
a server;
an access point in communication with the server, the access point comprising an access point clock set to a correct time;
at least one smart mesh device in communication with the access point, the smart mesh device comprising a device clock set to a device clock time and an advanced communication module having a module clock set to a module clock time;
wherein the advanced communication module:
an offset between the correct time and the module clock time;
determines that the offset is greater than a minimum offset; and
adjusts the module clock to the correct time.

18. A mesh network system according to claim 17, wherein the minimum offset is configurable by a user.

19. A mesh network system according to claim 17, wherein the advanced communication module:
receives a device clock time from the device clock;
determines an offset between the correct time and the device clock time;
determines that the offset is greater than a minimum drift parameter;
adjusts the device clock to the correct time; and
sets an error flag, and, optionally, sends an error message to the server when the offset is greater than a maximum drift parameter.

20. A mesh network system according to claim 19, wherein the maximum drift parameter and/or minimum drift parameter are configurable by a user.
